(19) United States
(12) Patent Application Publication
(10) Pub. No.: US 2012/0070077 A1
(43) Pub. Date: Mar. 22, 2012

(54) METHOD FOR OPTICALLY SCANNING AND MEASURING AN ENVIRONMENT

(75) Inventors: Martin Ossig, Tamm (DE); Ivan Bogicevic, Esslingen (DE); Norbert Bücking, Berlin (DE)

(73) Assignee: FARO TECHNOLOGIES, INC., Lake Mary, FL (US)

(21) Appl. No.: 13/259,383

(22) PCT Filed: Mar. 22, 2010
(86) PCT No.: PCT/EP10/01780

§ 371 Date: Dec. 2, 2011

(30) Foreign Application Priority Data
Mar. 25, 2009 (DE) 102009015921.5

(51) Int. Cl. G06K 9/34; H04N 7/18

(52) U.S. Cl. 382/164; 348/135; 348/E07.085

(57) ABSTRACT

With a method for optically scanning and measuring an environment by means of a laser scanner, which has a center, and which, for making a scan, optically scans and measures its environment by means of light beams and evaluates it by means of a control and evaluation unit, wherein a color camera having a center takes colored images of the environment which must be linked with the scan, the control and evaluation unit of the laser scanner, to which the color camera is connected, links the scan and the colored images and corrects deviations of the center and/or the orientation of the color camera relative to the center and/or the orientation of the laser scanner by virtually moving the color camera iteratively for each colored image and by transforming at least part of the colored image for this new virtual position and/or orientation of the color camera, until the projection of the colored image and the projection of the scan onto a common reference surface comply with each other in the best possible way.

### CROSS REFERENCE TO RELATED APPLICATIONS

The present application is a National Stage Application of PCT Application No. PCT/EP2010/001780 filed on Mar. 22, 2010, which claims the benefit of U.S. Provisional Patent Application No. 61/299,586 filed on Jan. 29, 2010, and of pending German Patent Application No. DE 10 2009 015 921.5, filed on Mar. 25, 2009, and which are hereby incorporated by reference.

### BACKGROUND OF THE INVENTION

The invention relates to a method for optically scanning and measuring an environment.

By means of a laser scanner such as is known for example from DE 20 2006 005 643, the environment of a laser scanner can be optically scanned and measured by means of a laser scanner. For gaining additional information, a camera, which takes RGB signals, is mounted on the laser scanner, so that the measuring points of the scan can be completed by color information. The camera holder is rotatable. To avoid parallax errors, the camera, for taking its records, is swiveled onto the vertical rotational axis of the laser scanner, and the laser scanner is lowered until the camera has reached the horizontal rotational axis. This method requires a high precision of the components.

### SUMMARY OF THE INVENTION

Embodiments of the present invention are based on the object of creating an alternative to the method of the type mentioned hereinabove.

With a rough knowledge of camera position and orientation, which may be relative to the center and to the orientation of the laser scanner, which, however, is not sufficient for a direct link, the method according to embodiments of the present invention makes it possible to correct the deviations of the centers and their orientations by means of the control and evaluation unit and to link scan and color images. The color camera, instead of making a real movement, which strongly depends on mechanical precision, carries out just a virtual movement, i.e. a transformation of the color images. Correction is made iteratively for every single color image. Comparison between scan and color images takes place on a common projection screen which is taken as a reference surface. Provided that the color camera is mounted and dismounted, i.e. a certain distance to the laser scanner is established before the scan is made, or that it is moved by means of an adjustable holder, the method according to embodiments of the present invention corrects the resulting changes of position and orientation.

At first, compliance is provided only for the regions of interest of the corresponding color image with the corresponding regions of interest of the scan, thus improving performance. Regions of interest are those regions showing relatively large changes over a short distance and may be found automatically, for example by means of gradients. Alternatively, it is possible to use targets, i.e. check marks which, however, have the drawback of covering the area behind them.

Within the iteration loop, the displacement vectors for the regions of interest, which are necessary to make the projections of the regions of interest of color image and scan compliable, are computed after each virtual movement. The notion “displacement” designates also those cases in which a rotation of the region of interest is additionally necessary.

During every step of the method, there will be the problem that, due to noise or the like, there is no exact compliance, and particularly no pixel-to-pixel compliance, of color image and scan. It is, however, possible to determine threshold values and/or intervals, which serve for discrimination and definition of precision. Statistical methods can be applied as well.

Embodiments of the method of the present invention do not trust in simple gradient-based dynamics (as they are used according to known methods), as it starts iterations at different virtual camera positions and as it defines criteria of exclusion. Thus, the embodiments of the method of the present invention even work if secondary minima occur. Therefore, the embodiments of the method of the present invention are robust even in case of a large distance between laser scanner and color camera. Using regions of interest results in a higher performance and in a higher success of finding corresponding counterparts. Regions are eliminated (by the criteria of exclusion), for which it is difficult or impossible to find corresponding regions, e.g. when laser scanner and color camera see different images (due to different wave lengths). With respect to this, a classification of the regions of interest is helpful.

Embodiments of the method of the present invention may also be used for calibration after mounting the color camera on the laser scanner.

### BRIEF DESCRIPTION OF THE DRAWINGS

The invention is explained in more detail below on the basis of exemplary embodiments illustrated in the drawings, in which

FIG. 1 shows a schematic illustration of optical scanning and measuring by means of a laser scanner and a color camera;

FIG. 2 shows a schematic illustration of a laser scanner without color camera; and

FIG. 3 shows a partial sectional view of the laser scanner with color camera.

### DETAILED DESCRIPTION OF THE INVENTION

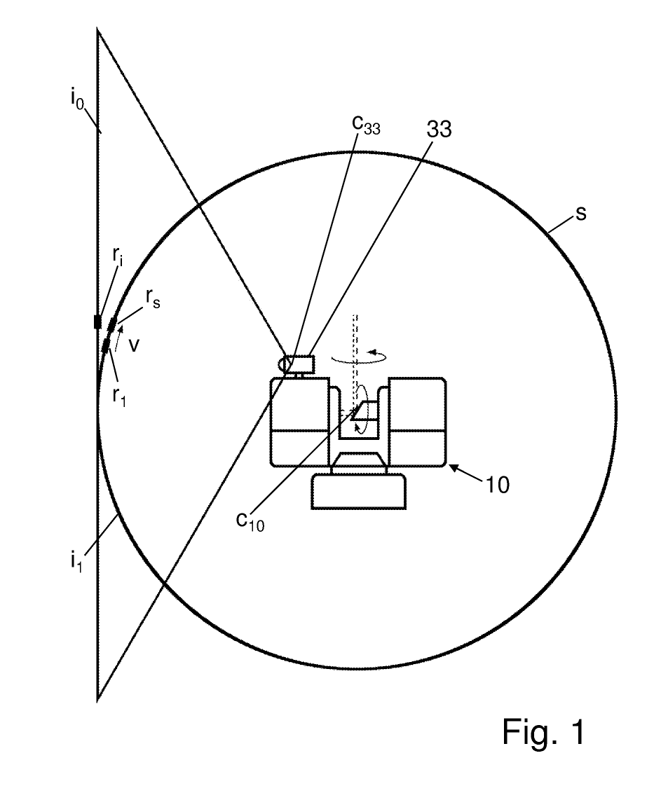

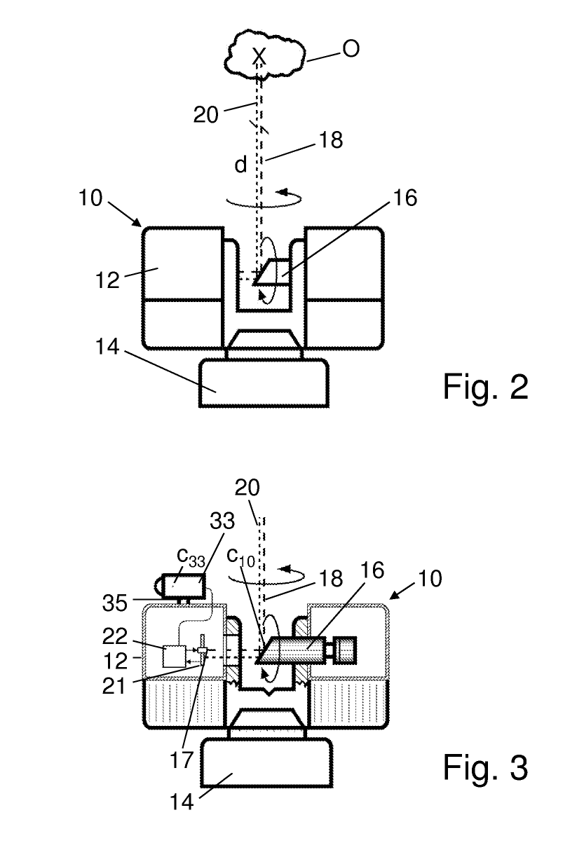

Referring to FIGS. 1-3, a laser scanner 10 is provided as a device for optically scanning and measuring the environment of the laser scanner 10. The laser scanner 10 has a measuring head 12 and a base 14. The measuring head 12 is mounted on the base 14 as a unit that can be rotated around a vertical axis. The measuring head 12 has a mirror 16, which can be rotated around a horizontal axis. The intersection point of the two rotational axes is designated center C₁₀ of the laser scanner 10.

The measuring head 12 is further provided with a light emitter 17 for emitting an emission light beam 18. The emission light beam 18 may be a laser beam in the visible range of approx. 300 to 1000 nm wavelength, such as 790 nm. On principle, also other electro-magnetic waves having, for example, a greater wavelength can be used. The emission light beam 18 is amplitude-modulated, for example with a sinusoidal or with a rectangular-waveform modulation signal. The emission light beam 18 is emitted by the light emitter 17 onto the mirror 16, where it is deflected and emitted to the environment. A reception light beam 20 which is reflected in the environment by an object O or scattered otherwise, is captured by the mirror 16, deflected and directed onto a light receiver 21. The direction of the emission light beam 18 and of the reception light beam 20 results from the angular positions of the mirror 16 and the measuring head 12, which depend on the positions of their corresponding rotary drives which, in turn, are registered by one encoder each. A control and evaluation unit 22 has a data connection to the light emitter 17 and to the light receiver 21 in measuring head 12, whereby parts of it can be arranged also outside the measuring head 12, for example a computer connected to the base 14. The control and evaluation unit 22 determines, for a multitude of measuring points X, the distance d between the laser scanner 10 (i.e. the center C₁₀) and the (illuminated point at) object O, from the propagation time of emission light beam 18 and reception light beam 20. For this purpose, the phase shift between the two light beams 18 and 20 is determined and evaluated.

Scanning takes place along a circle by means of the relatively quick rotation of the mirror 16. By virtue of the relatively slow rotation of the measuring head 12 relative to the base 14, the whole space is scanned step by step, by means of the circles. The entity of measuring points X of such a measurement is designated scan s. For such a scan s, the center C₁₀ of the laser scanner 10 defines the stationary reference system of the laser scanner, in which the base 14 rests. Further details of the laser scanner 10 and particularly of the design of measuring head 12 are described for example in U.S. Pat. No. 7,430,068 and DE 20 2006 005 643, the respective disclosures being incorporated by reference.

In addition to the distance d to the center C₁₀ of the laser scanner 10, each measuring point comprises a brightness which is determined by the control and evaluation unit 22 as well. The brightness is a gray-tone value which, for example, is determined by integration of the bandpass-filtered and amplified signal of the light receiver 21 over a measuring period which is attributed to the measuring point X.

For certain applications it would be desirable if, in addition to the gray-tone value, color information were available, too. According to embodiments of the present invention, the device for optically scanning and measuring an environment comprises a color camera 33 which is connected to the control and evaluation unit of the laser scanner 10 as well. The color camera 33 may be provided with a fisheye lens which makes it possible to take images within a wide angular range. The color camera 33 is, for example, a CCD camera or a CMOS camera and provides a signal which is three-dimensional in the color space, preferably an RGB signal, for a two-dimensional image in the real space, which, in the following, is designated colored image i₀. The center C₃₃ of the color camera 33 is taken as the point from which the color image i₀ seems to be taken, for example the center of the aperture.

In the exemplary embodiment described herein, the color camera 33 is mounted at the measuring head 12 by means of a holder 35 so that it can rotate around the vertical axis, in order to take several colored images i₀ and to thus cover the whole angular range. The direction from which the images are taken with respect to this rotation can be registered by the encoders. In DE 20 2006 005 643, a similar arrangement is described for a line sensor which takes colored images, too, and which, by means of an adjustable holder, can be shifted vertically, so that its center can comply with the center C₁₀ of the laser scanner 10. For the solution according to embodiments of the present invention, this is not necessary and therefore undesirable since, with an imprecise shifting mechanism, parallax errors might occur. It is sufficient to know the rough relative positions of the two centers C₁₀ and C₃₃, which can be estimated well if a rigid holder 35 is mounted, since, in such case, the centers C₁₀ and C₃₃ have a determined distance to each other. It is also possible, however, to use an adjustable holder 35 which, for example, swivels the color camera 33.

The control and evaluation unit 22 links the scan s (which is three-dimensional in real space) of the laser scanner 10 with the colored images i₀ of the color camera 33 (which are two-dimensional in real space), such process being designated “mapping”. The deviations of the centers C₁₀ and C₃₃ and, where applicable, of the orientations are thus corrected. Linking takes place image after image, for each of the colored images i₀, in order to give a color (in RGB shares) to each measuring point X of the scan s, i.e. to color the scan s. In a preprocessing step, the known camera distortions are eliminated from the colored images i₀. Starting mapping, according to embodiments of the present invention, the scan s and every colored image i₀ are projected onto a common reference surface, preferably onto a sphere. Since the scan s can be projected completely onto the reference surface, the drawing does not distinguish between the scan s and the reference surface.

The projection of the colored image i₀ onto the reference surface is designated i₁. For every colored image i₀, the color camera 33 is moved virtually, and the colored image i₀ is transformed (at least partially) for this new virtual position (and orientation, if applicable) of the color camera 33 (including the projection i₁ onto the reference surface), until the colored image i₀ and the scan s (more exactly their projections onto the reference surface) obtain the best possible compliance. The method is then repeated for all other colored images i₀.

In order to compare the corresponding colored image i₀ with the scan s, relevant regions, called regions of interest rᵢ, are defined in the colored image i₀. These regions of interest rᵢ may be regions which show considerable changes (in brightness and/or color), such as edges and corners or other parts of the contour of the object O. Such regions can be found automatically, for example by forming gradients and looking for extrema. The gradient, for example, changes in more than one direction, if there is a corner. In the projection of the scan s onto the reference surface, the corresponding regions of interest rₛ are found. For mapping, the regions of interest rᵢ are used in an exemplary manner.

For every single region of interest rᵢ of the colored image i₀, the region of interest rᵢ is transformed in a loop with respect to the corresponding virtual position of the color camera 33 and projected onto the reference surface. The projection of the region of interest rᵢ is designated r₁. The displacement vector v on the reference surface is then determined, i.e. how much the projection r₁ of the region of interest rᵢ must be displaced (and turned), in order to hit the corresponding region of interest rₛ in the projection of the scan s onto the reference surface. The color camera 33 is then moved virtually, i.e. its center C₃₃ and, if necessary, its orientation are changed, and the displacement vectors v are computed again. The iteration is aborted when the displacement vectors v show minimum values.

With the virtual position and, if applicable, orientation of the color camera 33 which have then been detected, the projection i₁ of the complete colored image and the projection of the scan s onto the reference surface comply with each other in every respect. Optionally, this can be checked by means of the projection i₁ of the complete colored image and the projection of the scan s.

Threshold values and/or intervals, which serve for discrimination and definition of precision, are determined for various comparisons. Even the best possible compliance of scan s and colored image i₀ is given only within such limits. Digitalization effects which lead to secondary minima, can be eliminated by means of distortion with Gaussian distribution.

In order to avoid the disadvantages of simple gradient-based dynamics (as they are used according to known methods), which have problems with secondary minima, embodiments of the method of the present invention may use two improvements:

First, a plurality of iterations for virtually moving the color camera 33 is performed, each iteration starting at a different point. If different (secondary) minima are found, the displacement vectors v resulting in the lowest minimum indicate the best virtual position (and orientation) of the color camera 33.

Second, criteria for exclusion are used to eliminate certain regions of interest rᵢ and/or certain virtual positions (and orientations) of the color camera 33. One criterion may be a spectral threshold. The region of interest rᵢ is subjected to a Fourier transformation, and a threshold frequency is defined. If the part of the spectrum below the threshold frequency is remarkably larger than the part of the spectrum exceeding the threshold frequency, the region of interest rᵢ has a useful texture. If the part of the spectrum below the threshold frequency is about the same as the part of the spectrum exceeding the threshold frequency, the region of interest rᵢ is dominated by noise and therefore eliminated. Another criterion may be an averaging threshold. If each of a plurality of regions of interest rᵢ results in a different virtual position of the color camera 33; a distribution of virtual positions is generated. The average position is calculated from this distribution. Regions of interest rᵢ are eliminated whose virtual position exceed a threshold for the expected position based on the distribution and will therefore be considered an outlier.

1. A method for optically scanning and measuring an environment wherein a laser scanner has a center and which, for making a scan optically scans and measures the environment by light beams and evaluates the environment by a control and evaluation unit, wherein a color camera is connected to the laser scanner and has a center and takes colored images of the environment, the method comprising the steps of:
correcting deviations of the center and/or the orientation of the color camera from the center and/or the orientation of the laser scanner by virtually moving the color camera iteratively for each one of the colored images and by transforming at least part of each one of the colored images for the corresponding virtual position and/or orientation of the color camera until the projection of each one of the colored images and the projection of the scan onto a common reference surface comply with each other, thereby linking the scan with the colored images.

2. The method of claim 1, further comprising the steps of defining at least one region of interest within each one of the colored images and comparing the defined at least one region of interest with the corresponding region of interest of the projection of the scan on the reference surface.

3. The method of claim 2, wherein a corner, an edge or another part of the contour of an object defined as the region of interest.

4. The method of claim 2, further comprising the steps of after each virtual movement of the color camera, transforming and projecting the region of interest of the colored image onto the reference surface.

5. The method of claim 4, further comprising the step of determining the displacement vector of the projection of the region of interest of the colored image on the corresponding region of interest of the projection of the scan on the reference surface.

6. The method of claim 5, wherein the steps of virtual movement of the color camera, the transformation of the region of interest and the determination of the displacement vector are iterated, until the projection of the colored image and the projection of the scan comply with each other.

7. The method of claim 6, wherein a plurality of iterations is started at different virtual positions of the color camera.

8. The method of claim 2, wherein criteria for exclusion are used to eliminate certain regions of interest and/or certain virtual positions and orientations of the color camera.

9. A device, comprising:
a laser scanner having a center and a control and evaluation unit, wherein the laser scanner is configured to make a scan by optically scanning and measuring an environment by light beams, wherein the control and evaluation unit is configured to evaluate the environment; and
a color camera, which is connected to the control and evaluation unit of the laser scanner, has a center and is configured to take colored images of the environment;
wherein the control and evaluation unit is configured to correct for any deviations of the center and/or the orientation of the color camera from the center and/or the orientation of the laser scanner by virtually moving the color camera iteratively for each one of the colored images and by transforming at least part of each one of the colored images for the corresponding virtual position and/or orientation of the color camera until the projection of each one of the colored images and the projection of the scan onto a common reference surface comply with each other, thereby linking the scan with the colored images.

10. The device of according to claim 9, wherein the color camera is mounted to a rotating part of the laser scanner by a holder.

11. The device of according to claim 9, wherein the center of the laser scanner and the center of the color camera have a determined distance to each other or are taken to a determined distance to each other before a scan is made.

12. The device of claim 9, wherein the color camera is a CCD camera or a CMOS camera.
